(19) United States
(12) Patent Application Publication
(10) Pub. No.: US 2017/0024918 A1
(43) Pub. Date: Jan. 26, 2017

(54) SERVER AND METHOD OF PROVIDING DATA

(71) Applicant: OPTiM Corporation, Saga (JP)

(72) Inventor: Shunji SUGAYA, Tokyo (JP)

(21) Appl. No.: 15/197,871

(22) Filed: Jun. 30, 2016

(30) Foreign Application Priority Data
Jul. 25, 2015 (JP) 2015-147280

(51) Int. Cl. G06T 11/60; G06F 17/30; G06T 5/50

(52) U.S. Cl. CPC G06T 11/60; G06T 5/50; G06F 17/3028; G06T 2207/20221; G06T 2207/30201

(57) ABSTRACT

A server communicatively connected with a customer terminal used by a customer and an operator terminal directing the customer includes a skin image data database that associates and stores skin image data on the customer, cosmetic data on the type of a cosmetic, and made-up skin image data on the customer indicated from the skin image data who has used the cosmetic indicated from the cosmetic data; receives skin image data imaged with the camera of the customer terminal; receives cosmetic data selected by the operator from the operator terminal; and searches the skin image data database based on the received skin image data and cosmetic data and extracts made-up skin image data corresponding to the received cosmetic data.

### CROSS REFERENCE TO RELATED APPLICATIONS

This application claims priority to Japanese Patent Application No. 2015-147280 filed on Jul. 25, 2015, the entire contents of which are incorporated by reference herein.

### TECHNICAL FIELD

The present invention relates to a server communicatively connected with a customer terminal used by a customer and an operator terminal directing the customer, and a method of providing data.

### BACKGROUND ART

Recently, the simulators displaying the image of a subject's virtually made-up face on the screen have been known for the research and development of cosmetics or the make-up advice in shops.

Such simulators take a subject's face image and superimpose the image of a made-up face on the face image (refer to Patent Document 1).

### CITATION LIST

### Patent Literature

Patent Document 1: JP 2009-53981 A

### SUMMARY OF INVENTION

Patent Document 1 extracts the feature point of a face image, compares the feature point of a two-dimensionally projected standard made-up form with this extracted feature point, distorts the standard made-up form so that the feature point of the two-dimensionally projected made-up form corresponds to the subject's feature point, superimposes the distorted standard made-up form on the subject's face image, so as to generate the image of a virtually made-up face that the subject desires.

However, such a constitution may increase the processing time because it requires complex processes such as the extraction of the feature point, and the formation of and the distortion of the standard made-up form.

In view of the above-mentioned problems, an objective of the present invention is to provide a server and a method of providing data that are capable of extracting a customer's skin image after the makeup in a short time.

The first aspect of the present invention provides a server communicatively connected with a customer terminal used by a customer and an operator terminal directing the customer, including:

a skin image data database that associates and stores skin image data on the customer, cosmetic data on the type of a cosmetic, and made-up skin image data on the customer indicated from the skin image data who has used the cosmetic indicated from the cosmetic data;

a skin image data receiving unit that receives skin image data imaged with the camera of the customer terminal;

a cosmetic data receiving unit that receives cosmetic data selected by the operator from the operator terminal; and

a made-up skin image extracting unit that searches the skin image data database based on the received skin image data and cosmetic data and extracts made-up skin image data corresponding to the received cosmetic data.

According to the first aspect of the present invention, a server communicatively connected with a customer terminal used by a customer and an operator terminal directing the customer includes a skin image data database that associates and stores skin image data on the customer, cosmetic data on the type of a cosmetic, and made-up skin image data on the customer indicated from the skin image data who has used the cosmetic indicated from the cosmetic data; receives skin image data imaged with the camera of the customer terminal; receives cosmetic data selected by the operator from the operator terminal; and searches the skin image data database based on the received skin image data and cosmetic data and extracts made-up skin image data corresponding to the received cosmetic data.

The first aspect of the present invention falls into the category of a server, but the category of a method of providing data has the same functions and effects.

The second aspect of the present invention provides the server according to the first aspect of the present invention further including: a face image data receiving unit that receives face image data on the customer's face from the customer terminal, the face image data being imaged with a camera; a data synthesizing unit that synthesizes the face image data by superimposing the extracted made-up skin image data on the face image data; and a face image data transmitting unit that transmits the synthesized face image data to the customer terminal.

According to the second aspect of the present invention, the server according to the first aspect of the present invention receives face image data on the customer's face from the customer terminal, the face image data being imaged with a camera; synthesizes the face image data by superimposing the extracted made-up skin image data on the face image data; and transmits the synthesized face image data to the customer terminal.

The third aspect of the present invention provides the server according to the first aspect of the present invention, further including: a partial face image data receiving unit that receives partial face image data on the customer's partial face from the customer terminal, the partial face image data being imaged with a camera; a data synthesizing unit that synthesizes the partial face image data by superimposing the extracted made-up skin image data on the partial face image data; and a partial face image data transmitting unit that transmits the synthesized partial face image data to the customer terminal.

According to the third aspect of the present invention, the server according to the first aspect of the present invention receives partial face image data on the customer's partial face from the customer terminal, the partial face image data being imaged with a camera; synthesizes the partial face image data by superimposing the extracted made-up skin image data on the partial face image data; and transmits the synthesized partial face image data to the customer terminal.

The fourth aspect of the present invention provides a method of providing data executed by a server communicatively connected with a customer terminal used by a customer and an operator terminal directing the customer, the server being provided with

a skin image data database that associates and stores skin image data on the customer, cosmetic data on the type of a cosmetic, and made-up skin image data on the customer indicated from the skin image data who has used the cosmetic indicated from the cosmetic data, the method including the steps of

receiving skin image data imaged with the camera of the customer terminal;

receiving cosmetic data selected by the operator from the operator terminal; and

searching the skin image data database based on the received skin image data and cosmetic data and extracting made-up skin image data corresponding to the received cosmetic data.

The present invention can provide a server and a method of providing data that are capable of extracting a customer's skin image after the makeup in a short time.

### BRIEF DESCRIPTION OF DRAWINGS

FIG. 1 shows a schematic diagram showing the data providing system 1.

FIG. 2 shows an overall configuration diagram of the data providing system 1.

FIG. 3 shows a functional block diagram of the server 10, the customer terminal 100, and the operator terminal 200.

FIG. 4 shows a flow chart of the data providing process executed by the server 10, the customer terminal 100, and the operator terminal 200.

FIG. 5 shows the skin image data database that the server 10 generates.

FIG. 6 shows a face image that the customer terminal 100 displays.

FIG. 7 shows a partial face image that the customer terminal 100 displays.

FIG. 8 shows a partial face image that the customer terminal 100 displays.

FIG. 9 shows a partial face image that the customer terminal 100 displays.

FIG. 10 shows skin image data and cosmetic data that the operator terminal 200 displays.

FIG. 11 shows a face image, a made-up image, and an operator image that the customer terminal 100 displays.

FIG. 12 shows a partial face image, a made-up image, and an operator image that the customer terminal 100 displays.

### DESCRIPTION OF EMBODIMENTS

Embodiments of the present invention will be described below with reference to the attached drawings. However, this is illustrative only, and the technological scope of the present invention is not limited thereto.

### Configuration of Data Providing System 1

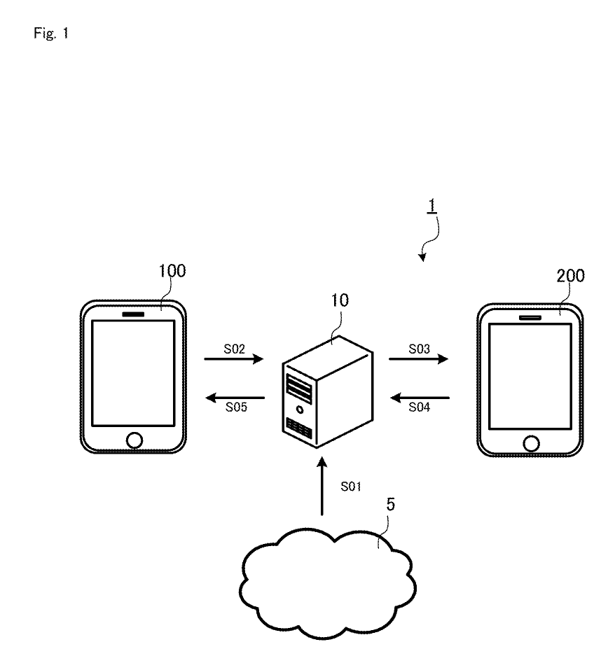

FIG. 1 shows an overview of the data providing system 1 according to a preferable embodiment of the present invention. The data providing system 1 includes a server 10, a customer terminal 100, and an operator terminal 200.

The server 10 is communicatively connected with a customer terminal 100 used by a customer and an operator terminal 200 directing the customer. The server 10 has a skin image data database that associates and stores skin image data on the customer, cosmetic data on the type of a cosmetic, and made-up skin image data on the customer indicated from the skin image data who has used the cosmetic indicated from the cosmetic data. The server 10 receives skin image data imaged with the camera of the customer terminal 100. The server 10 receives cosmetic data selected by the operator from the operator terminal 200. The server 10 searches the skin image data database based on the received skin image data and cosmetic data and extracts made-up skin image data corresponding to the received cosmetic data.

The server 10 also receives face image data on the customer's face imaged with the camera of the customer terminal 100. The server 10 synthesizes the face image data by superimposing the extracted made-up skin image data on the face image data. The server 10 transmits the synthesized face image data to the customer terminal 100.

The server 10 also receives partial face image data on the customer's partial face imaged with the camera of the customer terminal 100. The server 10 synthesizes the partial face image data by superimposing the extracted made-up skin image data on the partial face image data. The server 10 transmits the synthesized partial face image data to the customer terminal 100.

The customer terminal 100 and the operator terminal 200 are communicatively connected with the server 10.

The server 10 generates a skin image data database that associates unmade-up skin image data on the unmade-up skin image of the customer, cosmetic data on the type of a cosmetic, and made-up skin image data on the customer indicated from the skin image data who has used the cosmetic indicated from the cosmetic data (step S01). The server 10 acquires unmade-up skin image data, cosmetic data, and made-up skin image data through a public line network 5 such as the Internet and generates the skin image data database. The server 10 may acquire image data on the customer's face imaged with the imaging device that the customer terminal 100 or another terminal has as the unmade-up skin image data, cosmetic data on the cosmetic that this customer has actually used, and image data on the customer's face after the makeup as made-up skin image data to associate these data with each other and generate the skin image data database.

The customer terminal 100 images the customer's face with the camera and transmits the image of the face to the server 10 as face image data (step S02). The camera of the customer terminal 100 images the customer's entire or partial face such as the cheek, forehead, mouth, or nose.

The server 10 recognizes the received face image data and extracts skin image data. If the received face image data are on an entire face, the server 10 extracts the respective feature points of the parts to acquire skin image data on the parts. If the received face image data are on a partial face, the server 10 extracts the feature point of this part to acquire skin image data on the part.

The server 10 searches the skin image data database to extract unmade-up skin image data similar to the extracted skin image data and transmits the unmade-up skin image data to the operator terminal 200 (step S03). In the step S03, the server 10 recognizes the received skin image data, compares a plurality of feature points existing in the skin image data with a plurality of feature points existing in the unmade-up skin image data stored in the skin image data database, and extracts unmade-up skin image data similar to the skin image data. The server 10 may extract unmade-up skin image data similar to the received skin image data by another method.

The operator terminal 200 displays a skin image based on the received unmade-up skin image data, selects a cosmetic to be applied to this skin image, and transmits cosmetic data on the selected cosmetic to the server 10 (step S04).

The server 10 receives cosmetic data transmitted from the operator terminal 200. The server 10 searches the skin image data database based on the skin image data received from the customer terminal 100 and the cosmetic data received from the operator terminal 200 and extracts made-up skin image data corresponding to the received cosmetic data.

The server 10 synthesizes the face image data by superimposing the extracted made-up skin image data on the face image data received from the customer terminal 100 to generate synthesized face image data. If the face image data is on an entire face, the server 10 superimposes the made-up skin image data on the corresponding parts or the application parts indicated from the cosmetic data. If the face image data is on a partial face, the server 10 superimposes the made-up skin image data on this part.

The server 10 transmits the synthesized face image data to the customer terminal 100 (Step S05).

The customer terminal 100 receives and displays the synthesized face image data transmitted from the server 10.

### Configuration of Data Providing System 1

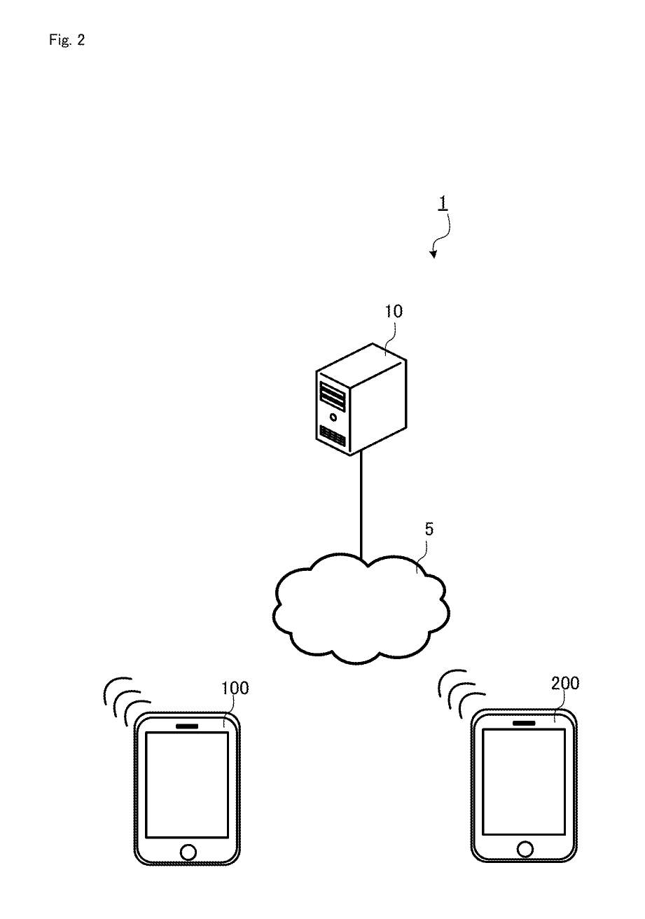

FIG. 2 shows a system configuration diagram of the data providing system 1 according to a preferable embodiment of the present invention. The data providing system 1 includes a server 10, a customer terminal 100, an operator server 200, and a public line network 5 (e.g. the Internet network, a third and a fourth generation networks).

The server 10 is a server device capable of data communication with the customer terminal 100 and the operator terminal 200. The server 10 has a skin image data database that associates and stores skin image data on the unmade-up skin image of the customer, cosmetic data on the type of a cosmetic, and made-up skin image data on the skin image data after the cosmetic indicated from the cosmetic data has been used. The server 10 receives skin image data imaged with the camera of the customer terminal 100. The server 10 receives cosmetic data selected by the operator from the operator terminal 200. The server 10 searches the skin image data database based on the received skin image data and cosmetic data and extracts made-up skin image data corresponding to the received cosmetic data.

The server 10 also receives face image data on the customer's face imaged with the camera of the customer terminal 100. The server 10 synthesizes the face image data by superimposing the extracted made-up skin image data on the face image data. The server 10 transmits the synthesized face image data to the customer terminal 100.

The server 10 also receives partial face image data on the customer's partial face imaged with the camera of the customer terminal 100. The server 10 synthesizes the partial face image data by superimposing the extracted made-up skin image data on the partial face image data. The server 10 transmits the synthesized partial face image data to the customer terminal 100.

The customer terminal 100 has functions to be described later and a capability of data communication, which is a home or office appliance that is carried and moved. Examples of the customer terminal 100 may include information appliances such as a mobile phone, a mobile information terminal, a smart phone, a notebook computer, a tablet terminal, a net book terminal, a slate terminal, an electronic book terminal, and a portable music player. The customer terminal 100 may be a fixed terminal installed in stores, facilities, etc.

The operator terminal 200 has functions to be described later and a capability of data communication, which is a home or office appliance that is carried and moved or a stationary appliance. Examples of the operator terminal 200 may include information appliances such as a mobile phone, a mobile information terminal, a smart phone, a notebook computer, a tablet terminal, a net book terminal, a slate terminal, an electronic book terminal, a portable music player, and a desktop. The operator terminal 200 may be a fixed terminal installed in stores, facilities, etc.

### Functions

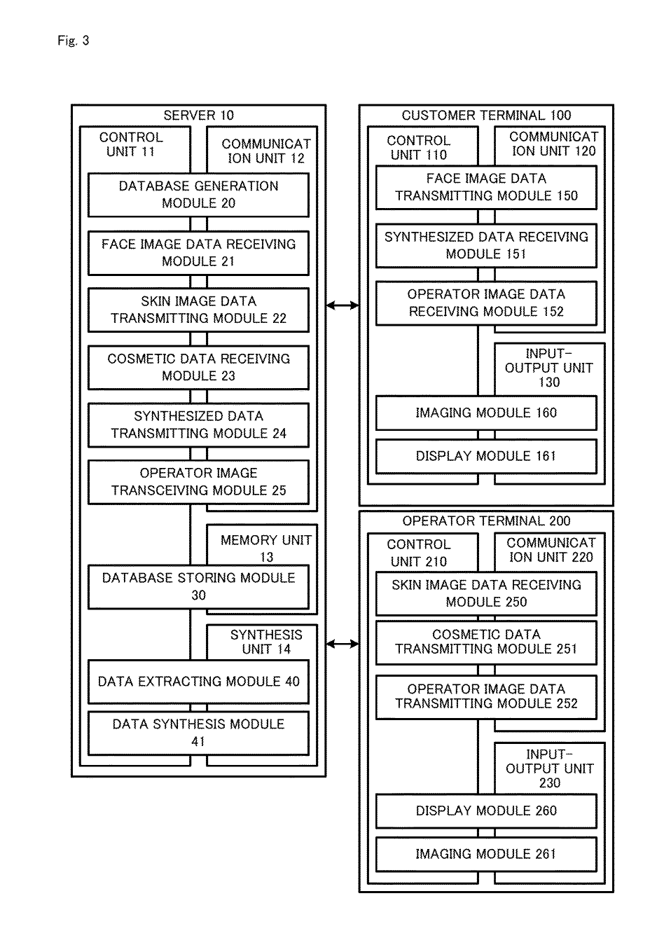

FIG. 3 shows a functional block diagram of the server 10, the customer terminal 100, and the operator terminal 200 to illustrate the relationship among their respective functions.

The server 10 includes a control unit 11 including a central processing unit (hereinafter referred to as “CPU”), a random access memory (hereinafter referred to as “RAM”), and a read only memory (hereinafter referred to as “ROM”); and a communication unit 12 including a Wireless Fidelity or Wi-Fi® enabled device complying with, for example, IEEE 802.11, or a wireless device complying with the IMT-2000 standard such as the third generation mobile communication system. The communication unit 12 may include a wired device for LAN connection.

The server 10 also includes a memory unit 13 such as a hard disk, a semiconductor memory, a record medium, or a memory card to store data. The memory unit 13 includes a skin image data database to be described later.

The server 10 also includes a device recognizing image data as a synthesis unit 14 or a device combining data on a plurality of images to synthesize data on one image.

In the server 10, the control unit 11 reads a predetermined program to run a database generation module 20, a face image data receiving module 21, a skin image data transmitting module 22, a cosmetic data receiving module 23, a synthesized data transmitting module 24, and an operator image transceiving module 25 in cooperation with the communication unit 12. Furthermore, in the server 10, the control unit 11 reads a predetermined program to run a database storing module 30 in cooperation with the memory unit 13. Still furthermore, in the server 10, the control unit 11 reads a predetermined program to run a data extracting module 40 and a data synthesis module 41 in cooperation with the synthesis unit 14.

The customer terminal 100 includes a control unit 110 including a CPU, a RAM, and a ROM; and a communication unit 120 such as a device capable of communicating with other devices, for example, a Wireless Fidelity or Wi-Fi® enabled device complying with IEEE 802.11 in the same way as the server 10. The customer terminal 100 also includes a device capable of wired connection.

The customer terminal 100 also includes an input-output unit 130 including a display unit outputting and displaying data and images that have been processed by the control unit 110; and an input unit such as a touch panel, a keyboard, or a mouse that receive an input from the customer. The customer terminal 100 also includes a device such as a camera to image the entire or partial face of the customer. The customer terminal 100 also includes a device capable of acquiring location information, such as a GPS.

In the customer terminal 100, the control unit 110 reads a predetermined program to run a face image data transmitting module 150, a synthesized data receiving module 151, and an operator image data receiving module 152 in cooperation with the communication unit 120. Furthermore, in the customer terminal 100, the control unit 110 reads a predetermined program to run an imaging module 160 and a display module 161 in cooperation with the input-output unit 130.

The operator terminal 200 includes a control unit 210 including a CPU, a RAM, and a ROM; and a communication unit 220 such as a device capable of communicating with other devices, for example, a Wi-Fi® enabled device complying with IEEE 802.11 in the same way as the customer terminal 100. The operator terminal 200 also includes a device capable of wired connection.

The operator terminal 200 also includes an input-output unit 230 including a display unit outputting and displaying data and images that have been processed by the control unit 210; and an input unit such as a touch panel, a keyboard, or a mouse that receive an input from the operator. The operator terminal 200 also includes a device such as a camera to image the operator's face. The operator terminal 200 also includes a device capable of acquiring location information, such as a GPS.

In the operator terminal 200, the control unit 210 reads a predetermined program to run a skin image data receiving module 250, a cosmetic data transmitting module 251, and an operator image data transmitting module 252 in cooperation with the communication unit 220. Furthermore, in the operator terminal 200, the control unit 210 reads a predetermined program to run a display module 260 and an imaging module 261 in cooperation with the input-output unit 230

### Data Providing Process

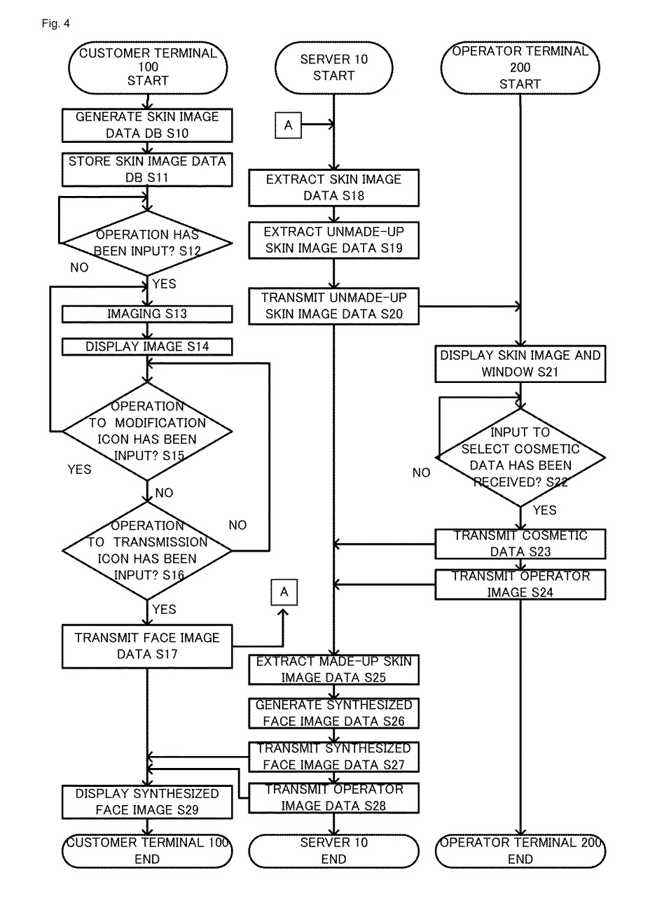

FIG. 4 shows a flow chart of the data providing process executed by the server 10, the customer terminal 100, and the operator terminal 200. The tasks executed by the modules of each of the above-mentioned units will be explained below together with this process.

First, the database generation module 20 of the server 10 generates a skin image data database that associates unmade-up skin image data on the unmade-up skin image of the customer, cosmetic data on the type of a cosmetic, and made-up skin image data on the skin image of the customer indicated from the unmade-up skin image data who has used the cosmetic indicated from the cosmetic data (step S10). The database generation module 20 acquires and associates a plurality of unmade-up skin image data, cosmetic data, and made-up skin image data to generate a skin image data database.

In the step S10, the database generation module 20 of the server 10 acquires unmade-up skin image data, cosmetic data, and made-up skin image data through a public line network 5 such as the Internet and generates the skin image data database. Moreover, the unmade-up skin image data that the database generation module 20 acquires may be on an entire or a partial face such as the eye, mouth, cheek, forehead, or nose. The database generation module 20 may acquire image data on the customer's face imaged with the imaging device such as a camera that the customer terminal 100 or the operator terminal 200 has as the unmade-up skin image data, cosmetic data on the cosmetic that this customer has actually used, and image data on the customer's face after the makeup as made-up skin image data to associate these data with each other and generate the skin image data database.

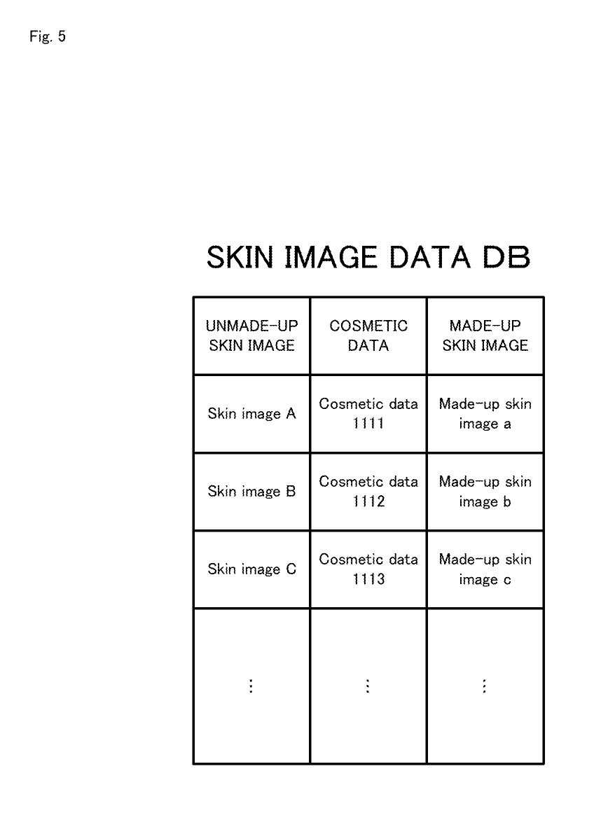

The database storing module 30 of the server 10 stores the skin image data database generated by the database generation module 20 as a skin image data database as shown in FIG. 5 (step S11).

### Skin Image Data Database

FIG. 5 shows the skin image data database that the database storing module 30 of the server 10 stores. The database storing module 30 associates and stores the above-mentioned unmade-up skin image data, cosmetic data, and made-up skin image data. In FIG. 5, the database storing module 30 associates and stores the skin image A as the unmade-up skin image data, the cosmetic data 1111 as cosmetic data, and the made-up skin image a as the made-up skin image data. The database storing module 30 also associates and stores the skin image B as the unmade-up skin image data, the cosmetic data 1112 as cosmetic data, and the made-up skin image b as the made-up skin image data. The database storing module 30 also associates and stores the skin image C as the unmade-up skin image data, the cosmetic data 1113 as cosmetic data, and the made-up skin image c as the made-up skin image data. Furthermore, the database storing module 30 associates and stores other unmade-up skin image data, cosmetic data, and made-up skin image data. The unmade-up skin image data stored by the database storing module 30 indicate the skin image of the entire or partial face of a customer. The cosmetic data stored by the database storing module 30 indicate a cosmetic to be used. Examples of the cosmetic data stored by the database storing module 30 include a foundation, an eyebrow pencil, a blusher, a lipstick, a gross, an eyeliner, an eye shadow, and an eyelash liner. The made-up skin image data stored by the database storing module 30 indicates an entire or partial face to which the cosmetic indicated from the cosmetic data has been applied.

First, the imaging module 160 of the customer terminal 100 judges whether or not the imaging module 160 has received an input of operation to image the customer's face (step S12). In the step S12, the imaging module 160 images the entire or partial face of the customer. Examples of the partial face of the customer that is imaged by the imaging module 160 include the eye, nose, mouth, cheek, and forehead. In the step S12, if judging that the imaging module 160 has not received an input of the operation (NO), the imaging module 160 repeats the process of this step until receiving an input of the operation.

On the other hand, if judging that the imaging module 160 has received an input of operation to image the customer's face (YES) in the step S12, the imaging module 160 of the customer terminal 100 images the customer's face (step S13).

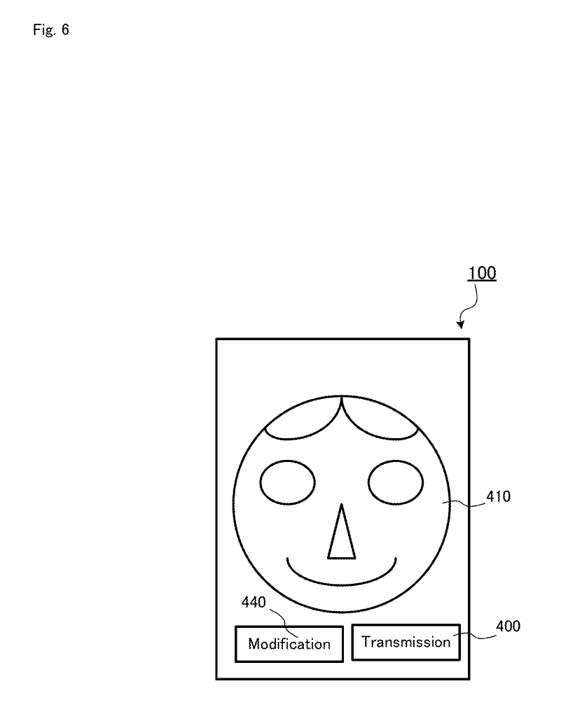

The display module 161 of the customer terminal 100 displays the face image of the customer, a transmission icon, and a modification icon as shown in FIGS. 6 to 9 (step S14).

The face image of the customer imaged by the imaging module 160 of the customer terminal 100 and displayed by the display module 161 of the customer terminal 100 will be explained below with reference to FIGS. 6 to 9.

FIG. 6 shows the case where the imaging module 160 of the customer terminal 100 images the entire face of the customer. In this case, the display module 161 displays the imaged entire face of the customer as a face image 410. The display module 161 displays a modification icon 440 and a transmission icon 400. If the display module 161 has received an input of operation to the transmission icon 400, the face image data transmitting module 150 of the customer terminal 100 transmits the face image data on the face image to the server 10. Furthermore, if the display module 161 has received an input of operation to the modification icon 440, the imaging module 160 images the customer's face again.

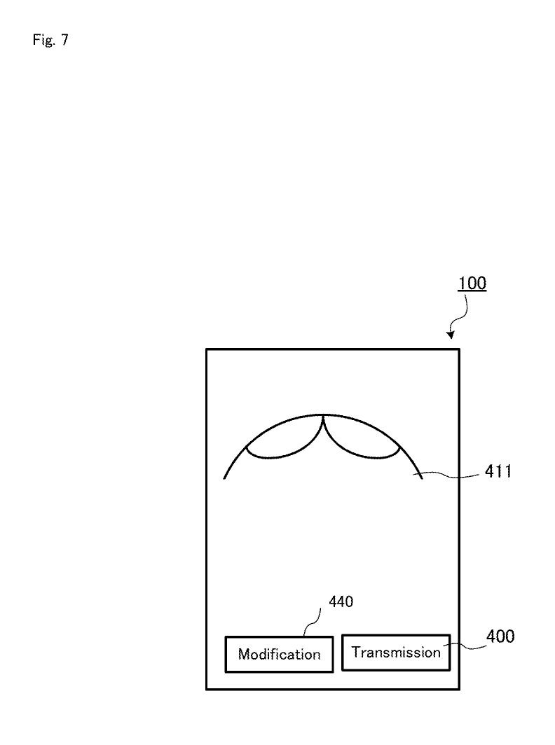

FIG. 7 shows the case where the imaging module 160 of the customer terminal 100 images the partial face of the customer. In this embodiment, the imaging module 160 images the forehead of the customer. In this case, the display module 161 displays the imaged partial face of the customer as a partial face image 411. The display module 161 displays a modification icon 440 and a transmission icon 400. If the display module 161 has received an input of operation to the transmission icon 400, the face image data transmitting module 150 of the customer terminal 100 transmits the partial face image data on the partial face image to the server 10. Furthermore, if the display module 161 has received an input of operation to the modification icon 440, the imaging module 160 images the customer's face again.

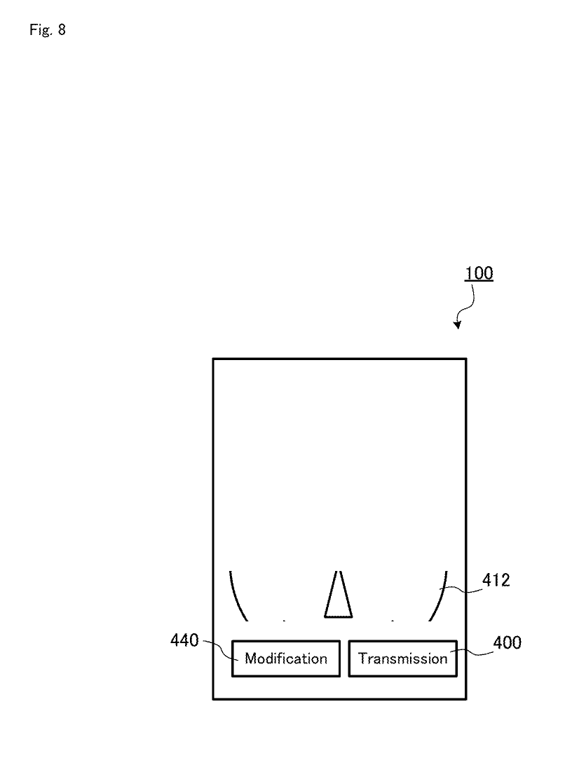

FIG. 8 shows the case where the imaging module 160 of the customer terminal 100 images the partial face of the customer. In this embodiment, the imaging module 160 images the cheek and the nose of the customer. In this case, the display module 161 displays the imaged partial face of the customer as a partial face image 412. The display module 161 displays a modification icon 440 and a transmission icon 400. If the display module 161 has received an input of operation to the transmission icon 400, the face image data transmitting module 150 of the customer terminal 100 transmits the partial face image data on the partial face image to the server 10. Furthermore, if the display module 161 has received an input of operation to the modification icon 440, the imaging module 160 images the customer's face again.

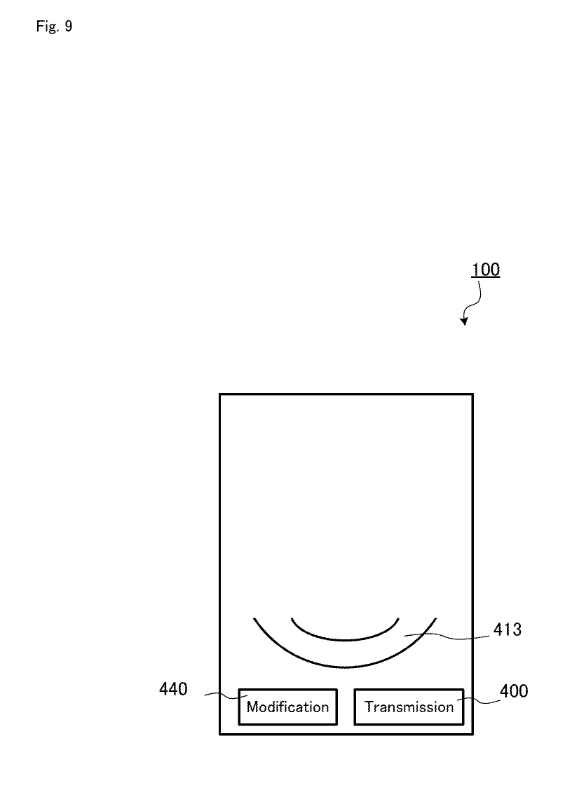

FIG. 9 shows the case where the imaging module 160 of the customer terminal 100 images the partial face of the customer. In this embodiment, the imaging module 160 images the mouth of the customer. In this case, the display module 161 displays the imaged partial face of the customer as a partial face image 413. The display module 161 displays a modification icon 440 and a transmission icon 400. If the display module 161 has received an input of operation to the transmission icon 400, the face image data transmitting module 150 of the customer terminal 100 transmits the partial face image data on the partial face image to the server 10. Furthermore, if the display module 161 has received an input of operation to the modification icon 440, the imaging module 160 images the customer's face again.

The display module 161 of the customer terminal 100 judges whether or not the display module 161 has received an input of operation to the modification icon 440 (step S15). In the step S15, if judging that the display module 161 has received an input of operation to the modification icon 440 (YES), the display module 161 images the customer's face again.

On the other hand, if judging that the display module 161 has not received an input of operation to the modification icon 440 (YES) in the step S15, the display module 161 of the customer terminal 100 judges whether or not the display module 161 has received an input of operation to the transmission icon 400 (step S16). If judging that the display module 161 has not received an input of operation to the transmission icon 400 (NO) in the step S16, the display module 161 repeats the process of the above-mentioned step S15.

If the display module 161 judges that the display module 161 has received an input of operation to the transmission icon 400 (YES) in the step S16, the face image data transmitting module 150 of the customer terminal 100 transmits the face image data imaged by the imaging module 160 to the server 10 (step S17).

The face image data receiving module 21 of the server 10 receives the face image data transmitted from the customer terminal 100. The data extracting module 40 of the server 10 recognizes the received face image data and extracts skin image data from the face image data (step S18). If the face image data that the face image data receiving module 21 has received is the entire face of a customer, the data extracting module 40 extracts feature points from the received face image data, specifies the specific parts such as the eyes, mouth, nose, cheek, and forehead in the face image data, and extracts skin image data on the parts. On the other hand, if the face image data that the face image data receiving module 21 has received is the partial face of a customer, the data extracting module 40 extracts a feature point from the received face image data, specifies the part indicated from the face image data, and extracts skin image data on this part.

The data extracting module 40 of the server 10 searches the skin image data database to extract unmade-up skin image data similar to the skin image data from the received face image data (step S19). In the step S19, the data extracting module 40 recognizes the skin image data extracted in the step S18, and retrieves and extracts unmade-up skin image data with a similar feature point to that of the skin image data from the skin image data database. The data extracting module 40 may extract unmade-up skin image data similar to the skin image data by another method.

The skin image data transmitting module 22 of the server 10 transmits the unmade-up skin image data extracted from the skin image data database by the data extracting module 40 to the operator terminal 200 (step S20).

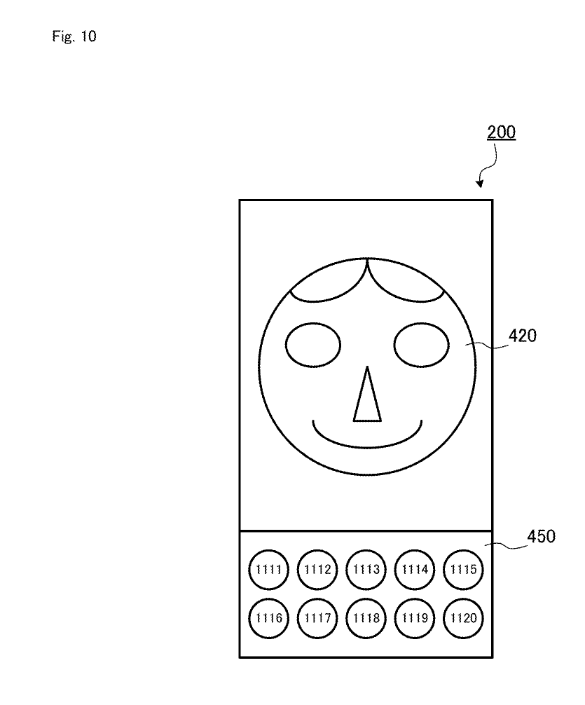

The skin image data receiving module 250 of the operator terminal 200 receives the skin image data transmitted from the server 10. The display module 260 of the operator terminal 200 displays a skin image 420 and a cosmetic data window 450 based on the received skin image data as shown in FIG. 10 (step S21). In the step S21, the display module 260 displays cosmetic data 1111 to 1120 indicating cosmetics to be applied to the skin image 420 in the cosmetic data window 450. The cosmetic data 1111 to 1120 that the display module 260 displays are stored in the skin image data database. The number of cosmetic data that the display module 260 displays is not limited to the number of this embodiment and may be more or less than this number. In the step S21, the display module 260 may display the skin image of not an entire but a partial face. In this case, only the skin image of the corresponding part is displayed.

The display module 260 of the operator terminal 200 judges whether or not the display module 260 has received an input from the operator to select cosmetic data (step S22). In the step S22, if judging that the display module 260 has not received an input from the operator to select cosmetic data (NO), the display module 260 repeats the process of this step until receiving an input of the selection.

On the other hand, if judging that the display module 260 of the operator terminal 200 has received an input from the operator to select cosmetic data (YES) in the step S22, the cosmetic data transmitting module 251 of the operator terminal 200 transmits the selected cosmetic data to the server 10 (step S23). The display module 260 may receive an input to select a plurality of cosmetic data, and the cosmetic data transmitting module 251 may transmit the plurality of cosmetic data to the server 10.

The operator image data transmitting module 252 of the operator terminal 200 transmits the image of the operator that the imaging module 261 of the operator terminal 200 has imaged and the operator image data on a previously registered image of the operator to the server 10 (step S24).

The cosmetic data receiving module 23 of the server 10 receives cosmetic data transmitted from the operator terminal 200. The data extracting module 40 of the server 10 searches the skin image data database based on the skin image data that was extracted from the face image data that has been received from the customer terminal 100 and the cosmetic data received from the operator terminal 200 and extracts made-up skin image data corresponding to the received cosmetic data (step S25). In the step S25, the data extracting module 40 retrieves unmade-up image data similar to the skin image data extracted from the face image data and made-up skin image data associated with the cosmetic data.

The data synthesis module 41 of the server 10 superimposes the extracted made-up skin image data on the skin image data extracted from the face image data received from the customer terminal 100 to generate synthesized face image data for this customer (step S26). In the step S26, if the face image data is on an entire face, the data synthesis module 41 superimposes the made-up skin image data on the corresponding parts or the application parts indicated from the cosmetic data. Furthermore, in the step S26, if the face image data is on a partial face, the data synthesis module 41 superimposes the made-up skin image data on this part. If the face image data is on a partial face, the data synthesis module 41 may synthesize face image data on the entire face from partial face image data on a plurality of parts of the face transmitted from one customer and then superimpose the made-up skin image data on the synthesized face image data.

The synthesized data transmitting module 24 of the server 10 transmits the synthesized face image data generated by the data synthesis module 41 in the step S26 to the customer terminal 100 (step S27).

The operator image data transceiving module 25 of the server 10 receives the operator image data transmitted from the operator terminal 200 and transmits this operator image data to the customer terminal 100 (step S28).

The synthesized data receiving module 151 of the customer terminal 100 receives the synthesized face image data transmitted from the server 10. The operator image data receiving module 152 of the customer terminal 100 receives the operator image data transmitted from the server 10. The display module 160 of the customer terminal 100 displays the face image, the synthesized face image based on the received synthesized face image data, and the operator image based on the operator image data (step S29).

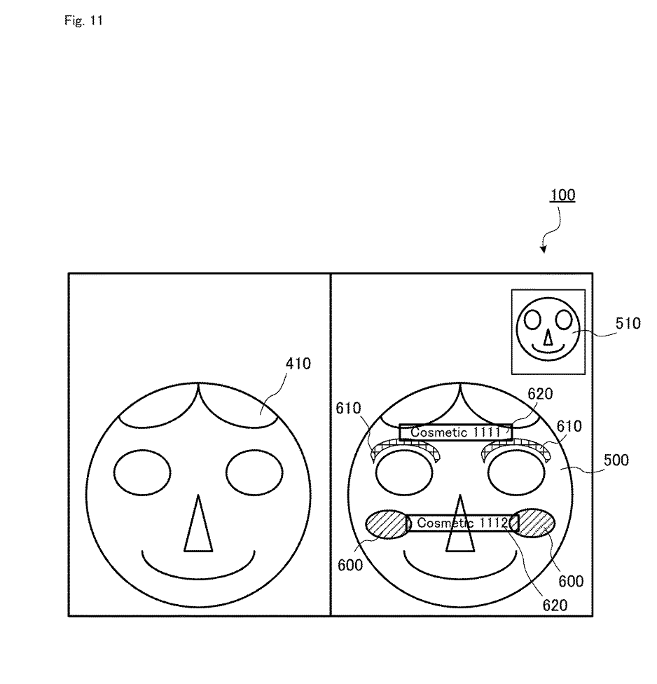

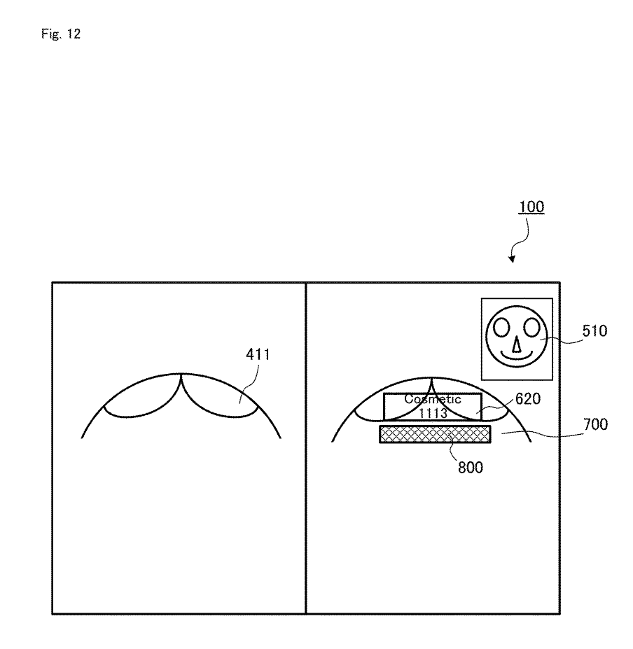

The screen that the display module 160 of the customer terminal 100 displays in the step S29 will be explained with reference to FIGS. 11 and 12.

FIG. 11 shows a face image, a synthesized face image, and an operator image that the display module 260 of the customer terminal 100 displays if the imaging module 261 of the customer terminal 100 has imaged the entire face of the customer. The display module 260 displays a face image 410, a synthesized face image 500, and an operator image 510. FIG. 11 shows that the cosmetics 600 and 610 are applied to the synthesized face image 500. The display module 260 displays a cosmetic data display window 620 showing the cosmetics 600 and 610 on or around the places where the cosmetics 600 and 610 have been applied. The display module 260 may display a cosmetic data display window 620 at other places. For example, the cosmetic data display window 620 may be displayed in a balloon or a blank area to show the cosmetic data being used and the application part in the operator image 510. The cosmetic data being used may be displayed when the customer selects the application part. The display module 260 may shows the cosmetic data being used and the application part by another method. In this embodiment, the display module 260 shows two kinds of cosmetic data but may be one kind or three or more kinds. The display module 260 may receive an input of the place to which a cosmetic is applied, from the customer, and may display cosmetic data and made-up skin image data for this place.

FIG. 12 shows a partial face image, a synthesized partial face image, and an operator image that the display module 260 of the customer terminal 100 displays if the imaging module 261 of the customer terminal 100 has imaged the partial face of the customer. The display module 260 displays a partial face image 411, a synthesized partial face image 700, and an operator image 510. FIG. 12 shows that the cosmetic 800 is applied to one part in the synthesized face image 700. The display module 260 displays a cosmetic data display window 620 showing cosmetics used on or around the places where the cosmetic 800 has been applied. The display module 260 may display a cosmetic data display window 620 at other places. For example, the cosmetic data display window 620 may be displayed in a balloon or a blank area to show the cosmetic data being used and the application part in the operator image 510. The cosmetic data being used may be displayed when the customer selects the application part. The display module 260 may shows the cosmetic data being used and the application part by another method. In this embodiment, the display module 260 shows one kind of cosmetic data but may be two or more kinds. The display module 260 may receive an input of the place to which a cosmetic is applied, from the customer, and may display cosmetic data and made-up skin image data for this place.

To achieve the means and the functions that are described above, a computer (including a CPU, an information processor, and various terminals) reads and executes a predetermined program. For example, a program is provided in forms recorded in a computer-readable record medium such as a flexible disk, a CD (e.g., CD-ROM), or a DVD (e.g., DVD-ROM, DVD-RAM). In this case, a computer reads a program from the record medium, forwards and stores the program to and in an internal or an external storage, and executes it. For example, the program may be previously recorded in a storage (record medium) such as a magnetic disk, an optical disk, or a magnetic optical disk, and then provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

### REFERENCE SIGNS LIST

10 Server

100 Customer terminal

200 Operator terminal

What is claimed is:

1. A server communicatively connected with a customer terminal used by a customer and an operator terminal directing the customer, comprising:
a skin image data database that associates and stores skin image data on the customer, cosmetic data on the type of a cosmetic, and made-up skin image data on the customer indicated from the skin image data who has used the cosmetic indicated from the cosmetic data;
a skin image data receiving unit that receives skin image data imaged with the camera of the customer terminal;
a cosmetic data receiving unit that receives cosmetic data selected by the operator from the operator terminal; and
a made-up skin image extracting unit that searches the skin image data database based on the received skin image data and cosmetic data and extracts made-up skin image data corresponding to the received cosmetic data.

2. The server according to claim 1, further comprising: a face image data receiving unit that receives face image data on the customer's face from the customer terminal, the face image data being imaged with a camera; a data synthesizing unit that synthesizes the face image data by superimposing the extracted made-up skin image data on the face image data; and a face image data transmitting unit that transmits the synthesized face image data to the customer terminal.

3. The server according to claim 1, further comprising: a partial face image data receiving unit that receives partial face image data on the customer's partial face from the customer terminal, the partial face image data being imaged with a camera; a data synthesizing unit that synthesizes the partial face image data by superimposing the extracted made-up skin image data on the partial face image data; and a partial face image data transmitting unit that transmits the synthesized partial face image data to the customer terminal.

4. A method of providing data executed by a server communicatively connected with a customer terminal used by a customer and an operator terminal directing the customer, the server being provided with a skin image data database that associates and stores skin image data on the customer, cosmetic data on the type of a cosmetic, and made-up skin image data on the customer indicated from the skin image data who has used the cosmetic indicated from the cosmetic data, the method comprising the steps of
receiving skin image data imaged with the camera of the customer terminal;
receiving cosmetic data selected by the operator from the operator terminal; and
searching the skin image data database based on the received skin image data and cosmetic data and extracting made-up skin image data corresponding to the received cosmetic data.
